(19) United States
(12) Patent Application Publication
(10) Pub. No.: US 2023/0382466 A1
(43) Pub. Date: Nov. 30, 2023

(54) Spray Mist Suppressor

(71) Applicant: Amrit Singh, Fremont, CA (US)

(72) Inventor: Amrit Singh, Fremont, CA (US)

(21) Appl. No.: 17/827,858

(22) Filed: May 30, 2022

(51) Int. Cl. B62D 25/18; B60R 16/08

(52) U.S. Cl. CPC B62D 25/18; B60R 16/08

(57) ABSTRACT

A spray mist suppressor removes spray mist generated behind one or more vehicle wheels once running along a wetted surface under spray mist generating conditions. The apparatus includes an intake duct having an intake inlet end and an intake outlet end, and a transition duct in environmental communication with the intake duct. The transition duct has a transition inlet end and a transition outlet end, wherein the transition duct has a cross-sectional area that is greater at the transition inlet end than at a location between the transition inlet end and the transition outlet end. The transition duct is configured to implement a Venturi effect to reduce a static pressure of a fluid within the transition duct flowing from the transition inlet end to the transition outlet end relative to a static pressure of the fluid outside of the transition duct. An aperture extends transversely through a wall of the transition duct and is configured to permit a suction force resulting from the Venturi effect to urge a spray mist into the transition duct.

A coalescing duct is in environmental communication with the transition duct and curves such that any of the spray mist contained within the coalescing duct coalesces into a flowing body of water. A discharge duct is in environmental communication with the coalescing duct and extends laterally from the coalescing duct to a discharge outlet end.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

### (2) DESCRIPTION OF RELATED ART INCLUDING INFORMATION DISCLOSED UNDER 37 CFR 1.97 AND

1.98.

The disclosure and prior art relate to spray mist suppressing apparatuses and more particularly pertains to a new spray mist suppressing apparatus for removing spray mist generated behind one or more vehicle wheels once running along a wetted surface under spray mist generating conditions.

### (h) BRIEF SUMMARY OF THE INVENTION

An embodiment of the disclosure meets the needs presented above by generally comprising an intake duct having an intake inlet end and an intake outlet end, and a transition duct in environmental communication with the intake duct. The transition duct has a transition inlet end and a transition outlet end, wherein the transition duct has a cross-sectional area that is greater at the transition inlet end than at a location between the transition inlet end and the transition outlet end. The transition duct is configured to implement a Venturi effect to reduce a static pressure of a fluid within the transition duct flowing from the transition inlet end to the transition outlet end relative to a static pressure of the fluid outside of the transition duct. An aperture extends transversely through a wall of the transition duct and is configured to permit a suction force resulting from the Venturi effect to urge a spray mist into the transition duct.

A coalescing duct is in environmental communication with the transition duct and curves such that any of the spray mist contained within the coalescing duct coalesces into a flowing body of water. A discharge duct is in environmental communication with the coalescing duct and extends laterally from the coalescing duct to a discharge outlet end.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a spray mist suppressor according to an embodiment of the disclosure.

FIG. 2 is a cross-sectional view of an embodiment of the disclosure.

FIG. 3 is a cross-sectional view of an embodiment of the disclosure in the direction of arrows A-A in FIG. 2.

FIG. 4 is a cross-sectional view of an embodiment of the disclosure.

FIG. 5 is a cross-sectional view of an embodiment of the disclosure.

### (j) DETAILED DESCRIPTION OF THE INVENTION

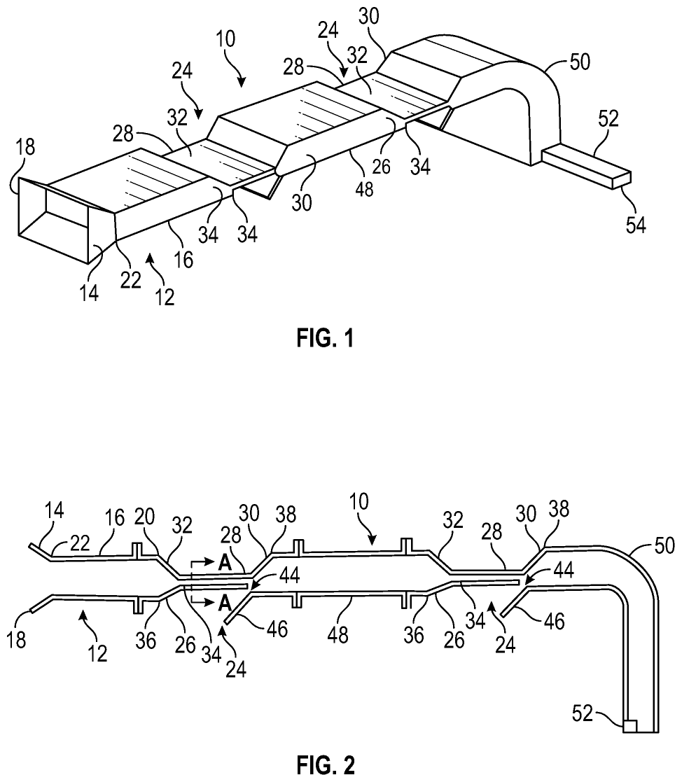

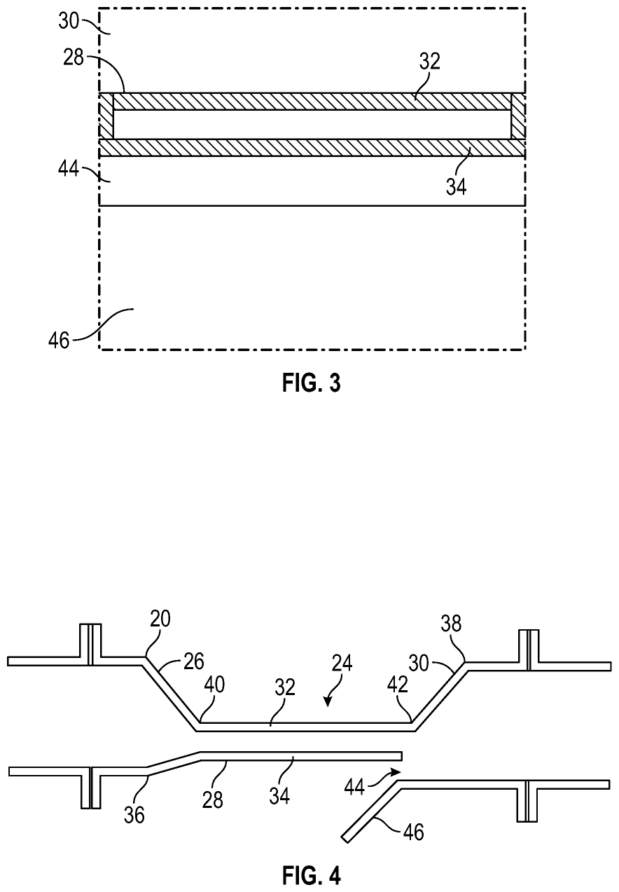

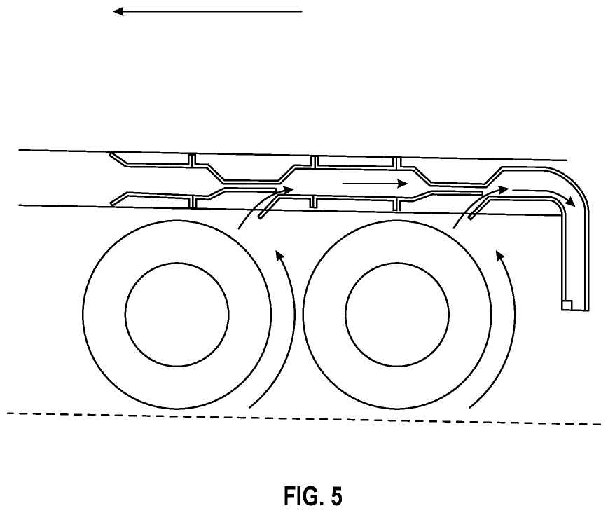

With reference now to the drawings, and in particular to FIGS. 1 through 6 thereof, a new spray mist suppressing apparatus embodying the principles and concepts of an embodiment of the disclosure and generally designated by the reference numeral 10 will be described.

As best illustrated in FIGS. 1 through 6, the spray mist suppressor 10 generally comprises an intake duct 12 which includes an intake inlet end 18 and an intake outlet end 20. The intake duct 12 includes a flared portion 14 and a straight portion 16 wherein the flared portion 14 is in environmental communication with the straight portion 16. A cross-sectional area of the flared portion 14 decreases from the intake inlet end 18 to a junction 22 of the flared portion 14 and the straight portion 16. A cross-sectional area of the straight portion 16 is constant from the junction 22 of the flared portion 14 and the straight portion 16 to the intake outlet end 20.

Each of a pair of transition ducts 24 has a transition inlet end 36 and a transition outlet end 38 and includes a reduction portion 26, a reduced portion 28, and an expansion portion 30. Each reduced portion 28 is in environmental communication with associated ones of the reduction portions 26 and the expansion portions 30. Each transition duct 24 has a top wall 32 and a bottom wall 34 wherein each top wall 32 and each bottom wall 34 extend from an associated one of the transition inlet ends 36 to an associated one of the transition outlet ends 38.

Each cross-sectional area of an associated one of the transition ducts 24 decreases from an associated one of the transition inlet ends 36 to a respective first junction 40. Each first junction 40 joins an associated one of the reduction portions 26 with an associated one of the reduced portions 28. Each top wall 32 extends from an associated one of the transition inlet ends 36 angled downwardly along an associated one of the reduction portions 26, while each bottom wall 34 extends from an associated one of the transition inlet ends 36 upwardly along an associated one of the reduction portions 26. Each top wall 32 extends farther downwardly along an associated one of the reduction portions 26 than an associated one of the bottom walls 34 extends upwardly along an associated one of the reduction portions 26, but the top wall 32 and bottom wall 34 may extend at other relative angles along the reduction portions.

Each cross-sectional area of an associated one of the transition ducts 24 is constant from an associated one of the first junctions 40 to a respective second junction 42. Each second junction 42 joins an associated one of the reduced portions 28 with an associated one of the expansion portions 30.

Each cross-sectional area of an associated one of the transition ducts 24 increases from an associated one of the second junctions 42 to an associated one of the transition outlet ends 38. Each top wall 32 extends from an associated one of the second junctions 42 angled upwardly along an associated one of the expansion portions 30, while each bottom wall 34 extends from an associated one of the second junctions 42 horizontally along an associated one of the expansion portions 30. However, each top wall 32 and each bottom wall 34 may extend at other angles along the expansion portions 30. Each bottom wall 34 along an associated one of the expansion portions 30 is lower than an associated one of the bottom walls 34 along an associated one of the reduced portions 28 but may be at the same height or higher.

Each transition duct 24 may have an alternative geometry that implements the Venturi effect to reduce a static pressure of a fluid within the transition duct 24 flowing from the transition inlet end 36 to the transition outlet end 38 relative to a static pressure of the fluid outside of the transition duct 24. A first of the transition ducts 24 is in environmental communication with the intake duct 12, wherein the transition inlet end 36 of the first of the transition ducts 24 is coupled to the intake outlet end 20. There may be only one transition duct 24, or there may be more than two transition ducts 24.

Each of a pair of apertures 44 extends through an associated one of the bottom walls 34 between an associated one of the reduced portions 28 and an associated one of the expansion portions 30 such that each reduced portion 28 defines a front edge of an associated one of the apertures 44 and each expansion portion 30 defines a rear edge of an associated one of the apertures 44. Each aperture 44 may extend through another wall of the transition duct 24. Each aperture 44 is rectangular, but may be circular, oblong, or another shape. Each aperture 44 extends across the full width of the associated one of the transition ducts 24 as shown but may be another length.

Each of a pair of guiding lips 46 extends from an associated one of the bottom walls 34 adjacent to an associated one of the rear edges of an associated one of the apertures 44. Each guiding lip 46 is angled to extend away from an associated one of the apertures 44 and toward an associated one of the transition inlet ends 36 and is configured to direct spray mist into an associated one of the apertures 44.

An expansion duct 48 is in environmental communication with the first of the transition ducts 24. A cross-sectional area of the expansion duct 48 is constant along a full length of the expansion duct 48. A second of the transition ducts 24 is in environmental communication with the expansion duct 48. The transition inlet of the second of the transition ducts 24 is coupled to the expansion duct 48.

A coalescing duct 50 is in environmental communication with the second of the transition ducts 24. The transition outlet end 38 of the second of transition ducts 24 is coupled to the coalescing duct 50. The coalescing duct 50 extends from the transition outlet end 38 of the second of transition ducts 24 and curves downwardly and is configured to cause any contained spray mist to coalesce into a flowing body of water. A discharge duct 52 is in environmental communication with the coalescing duct 50 and extends laterally from the coalescing duct 50 to a discharge outlet end 54.

With respect to the above description then, it is to be realized that the optimum dimensional relationships for the parts of an embodiment enabled by the disclosure, to include variations in size, materials, shape, form, function and manner of operation, apparatus and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded.

A reference to an element by the indefinite article “a” does not exclude the possibility that more than one of the element is present, unless the context clearly requires that there be only one of the elements.

I claim:

1. A spray mist suppressor comprising:
an intake duct having an intake inlet end and an intake outlet end,
a transition duct in environmental communication with said intake duct, said transition duct having a transition inlet end and a transition outlet end, said transition duct having a cross-sectional area, said cross-sectional area being greater at said transition inlet end than at a location between said transition inlet end and said transition outlet end wherein said transition duct is configured to implement a Venturi effect to reduce a static pressure of a fluid within said transition duct flowing from said transition inlet end to said transition outlet end relative to a static pressure of the fluid outside of said transition duct;
an aperture extending transversely through a wall of said transition duct wherein said aperture is configured to permit a suction force resulting from the Venturi effect to urge a spray mist into said transition duct;
a coalescing duct in environmental communication with said transition duct, said coalescing duct curving wherein said coalescing duct being configured to cause any of the spray mist contained within said coalescing duct to coalesce into a flowing body of water; and
a discharge duct in environmental communication with said coalescing duct, said discharge duct extending laterally from said coalescing duct to a discharge outlet end.

2. The apparatus of claim 1, wherein said intake duct includes a flared portion and a straight portion, wherein said flared portion is in environmental communication with said straight portion, wherein a cross-sectional area of said flared portion decreases from said intake inlet end to a junction of said flared portion and said straight portion, wherein a cross-sectional area of said straight portion is constant from said junction of said flared portion and said straight portion to said intake outlet end.

3. The apparatus of claim 1, wherein said transition duct includes a reduction portion, a reduced portion, and an expansion portion, wherein said reduced portion is in environmental communication with said reduction portion and said expansion portion,
wherein said cross-sectional area of said transition duct decreases from said transition inlet to a first junction, said first junction joining said reduction portion with said reduced portion,
wherein said cross-sectional area of said transition duct is constant from said first junction to a second junction, said second junction joining said reduced portion with said expansion portion,
wherein said cross-sectional area of said transition duct increases from said second junction to said transition outlet end.

4. The apparatus of claim 3, wherein said transition duct has a top wall and a bottom wall, said top wall and said bottom wall extending from said transition inlet end to said transition outlet end, wherein said top wall extends from said transition inlet angled downwardly along said reduction portion, wherein said bottom wall extends from said transition inlet upwardly along said reduction portion.

5. The apparatus of claim 4, wherein said top wall extends farther downward along said reduction portion than said bottom wall extends upward along said reduction portion.

6. The apparatus of claim 4, wherein said top wall extends from said second junction angled upwardly along said expansion portion, wherein said bottom wall extends from said second junction horizontally along said expansion portion.

7. The apparatus of claim 6, wherein said bottom wall along said expansion portion is lower than said bottom wall along said reduced portion.

8. The apparatus of claim 4, wherein said aperture extends through said bottom wall of said transition duct between said reduced portion and said expansion portion such that said reduced portion defines a front edge of said aperture and said expansion portion defines a rear edge of said aperture.

9. The apparatus of claim 8, further comprising a guiding lip extending from said bottom wall adjacent to said rear edge of said aperture, said guiding lip being angled to extend away from said aperture and toward said transition inlet end, wherein said guiding lip is configured to direct spray mist into said aperture.

10. The apparatus of claim 1, wherein said transition duct is one of a plurality of transition ducts.

11. The apparatus of claim 10, further comprising an expansion duct in environmental communication with one of said transition ducts, wherein a cross-sectional area of said expansion duct is constant along a full length of said expansion duct, wherein a second one of said transition ducts is in environmental communication with said expansion duct.

12. The apparatus of claim 1, wherein said coalescing duct extends from said transition outlet end and curves downwardly.

13. A spray mist suppressor comprising:
an intake duct including a flared portion and a straight portion, said intake duct having an intake inlet end and an intake outlet end, wherein said flared portion is in environmental communication with said straight portion, wherein a cross-sectional area of said flared portion decreases from said intake inlet end to a junction of said flared portion and said straight portion, wherein a cross-sectional area of said straight portion is constant from said junction of said flared portion and said straight portion to said intake outlet end,
a pair of transition ducts, each said transition duct having a transition inlet end and a transition outlet end, each said transition duct having a cross-sectional area, each said transition duct having a reduction portion, a reduced portion, and an expansion portion, wherein each said reduced portion is in environmental communication with an associated one of said reduction portions and an associated one of said expansion portions, wherein each said transition duct has a top wall and a bottom wall, each said top wall and each said bottom wall extending from an associated one of said transition inlet ends to an associated one of said transition outlet ends, wherein each said cross-sectional area of an associated one of said transition ducts decreases from an associated one of said transition inlet ends to a respective first junction, each said first junction joining an associated one of said reduction portions with an associated one of said reduced portions, wherein each said top wall extends from an associated one of said transition inlet ends angled downwardly along an associated one of said reduction portions,
wherein each said bottom wall extends from an associated one of said transition inlet ends upwardly along an associated one of said reduction portions, wherein each said top wall extends farther downwardly along an associated one of said reduction portions than an associated one of said bottom walls extends upwardly along an associated one of said reduction portions,
wherein each said cross-sectional area of an associated one of said transition ducts is constant from an associated one of said first junctions to a respective second junction, each said second junction joining an associated one of said reduced portions with an associated one of said expansion portions,
wherein each said cross-sectional area of an associated one of said transition ducts increases from an associated one of said second junctions to an associated one of said transition outlet ends, wherein each said top wall extends from an associated one of said second junctions angled upwardly along an associated one of said expansion portions, wherein each said bottom wall extends from an associated one of said second junctions horizontally along an associated one of said expansion portions, wherein each said bottom wall along an associated one of said expansion portions is lower than an associated one of said bottom walls along an associated one of said reduced portions,
wherein a first of said transition ducts is in environmental communication with said intake duct, said transition inlet end of said first of said transition ducts being coupled to said intake outlet end;
a pair of apertures, each said aperture extending through an associated one of said bottom walls between an associated one of said reduced portions and an associated one of said expansion portions such that each said reduced portion defines a front edge of an associated one of said apertures and each said expansion portion defines a rear edge of an associated one of said apertures;
a pair of guiding lips, each said guiding lip extending from an associated one of said bottom walls adjacent to an associated one of said rear edges of an associated one of said apertures, each said guiding lip being angled to extend away from an associated one of said apertures and toward an associated one of said transition inlet ends, wherein each said guiding lip is configured to direct spray mist into an associated one of said apertures;
an expansion duct in environmental communication with said first of said transition ducts, wherein a cross-sectional area of said expansion duct is constant along a full length of said expansion duct, wherein a second of said transition ducts is in environmental communication with said expansion duct, wherein said transition inlet of said second of said transition ducts is coupled to said expansion duct;
a coalescing duct in environmental communication with said second of said transition ducts, said transition outlet end of said second of transition ducts being coupled to said coalescing duct, wherein said coalescing duct extends from said transition outlet end of said second of transition ducts and curves downwardly, wherein said coalescing duct is configured to cause any contained spray mist to coalesce into a flowing body of water;
a discharge duct in environmental communication with said coalescing duct, wherein said discharge duct extends laterally from said coalescing duct to a discharge outlet end; and
a conduit extending from said intake inlet end, through said intake duct, through said first of said transition ducts, through said expansion duct, through said second of said transition ducts, through said coalescing duct, through said discharge duct, to said outlet end, wherein said conduit is configured to permit fluid to enter through said intake inlet end and exit through said discharge outlet end.
